(19) United States
(12) Patent Application Publication
(10) Pub. No.: US 2019/0021386 A1
(43) Pub. Date: Jan. 24, 2019

(54) HIGH-PROTEIN COMPOSITIONS AND METHODS OF THEIR MAKING AND USE

(71) Applicant: INTERNATIONAL DEHYDRATED FOODS, INC., Springfield, MO (US)

(72) Inventor: Jack C. CAPPOZZO, Springfield, MO (US)

(21) Appl. No.: 16/071,818

(22) PCT Filed: Jan. 22, 2017
(86) PCT No.: PCT/US2017/014473

§ 371 Date: Jul. 20, 2018

Related U.S. Application Data
(60) Provisional application No. 62/286,175, filed on Jan. 22, 2016.

(51) Int. Cl. A23L 33/175; A23L 33/185

(52) U.S. Cl. CPC A23L 33/175; A23L 33/185; A23V 2002/00; A23V 2200/3324; A23V 2250/542; A23V 2250/0654; A23V 2250/063; A23V 2250/0632; A23V 2250/0628; A23V 2250/0626; A23V 2250/0606

(57) ABSTRACT

Disclosed here are methods to deliver protein to people in need of high protein. Also disclosed are methods to improve the protein content of comfort foods. Dehydrated meat powder or broth may be used to enhance the protein content of comfort foods.

### RELATED APPLICATION

This application claims priority to U.S. patent application No. 62/286,175, filed Jan. 22, 2016, the entire content of which is hereby incorporated by reference into this application.

### BACKGROUND

### 1. Field of The Invention

This disclosure relates to a process for making comfort foods. More particularly, the present disclosure relates to methods for adding or delivering a high protein poultry composition with no fat or substantially no fat to meals and meal components to obtain a healthy meal solution with high quality protein with essential amino acid but a low or no fat content.

### 2. Description of Related Art

Protein and essential amino acids are essential nutrients and are desirable in the diet for the general population. These essential nutrients are even more important for certain populations, such as children, the elderly, and athletes. Comfort foods traditionally have low protein content.

### SUMMARY

The instrumentalities disclosed here provide compositions that are made by an improved process which enhances the protein content of the products. In one embodiment, the compositions made by the disclosed process may have higher protein content than traditional comfort foods while maintaining the same or similar taste. In another embodiment, the compositions made by the disclosed process may have higher protein content while maintaining relatively low fat content.

In one embodiment, the disclosed composition contains a protein mix and may have elevated protein content, wherein the protein mix contributes to the elevated protein content.

In another embodiment, examples of the comfort food may include but are not limited to macaroni & cheese, casserole, mashed potato, pot pie, spaghetti sauce, grilled cheese, pasta, noodle, snack crisps, chips, soup, chowder, sauce, grits, cereals, grain-creamed cereals, bread, battered dough, snack mix, gravy.

In another embodiment, the composition may be prepared for small scale use or it may be manufactured for commercial sale or use at a much larger scale.

In one aspect, the protein mix may be prepared from a source such as animal, plant or insect. In another aspect, the protein mix may be prepared from an organism selected from the group consisting of chicken, turkey, duck, ostrich, quail, goose, and combination thereof. In another aspect, the protein mix may be prepared from poultry, such as chicken or turkey.

In one embodiment, the disclosed composition may contain at least 5%, 10%, 20%, or at least 30% (w/w) protein. By adding the protein mix to the composition, the final protein content in the composition is substantially increased, without significantly increasing the fat content of the composition. In one aspect, the protein content in the composition may be increased by at least 30%, by at least 50%, by at least 100%, or by at least 200%. By way of example, if the comfort food typically contains 1% (w/w) of protein, an increase to 2% (w/w) protein content after addition of the protein mix is an increase of protein content by 100%.

Various ingredients of the composition may contribute to the increased protein content of the composition. In one embodiment, the protein mix that is added to the composition contributes to more than 50%, 60%, 70%, 80%, 90%, or about 95% of total protein content in the composition.

In one embodiment, dehydrated protein powder from poultry, such as dehydrated chicken powder, may be added directly or indirectly to comfort food as an ingredient, to increase the protein content. In another embodiment, dehydrated poultry powder may be added directly to low protein foods, such as macaroni & cheese, which may help increase the protein content while adding no significant amount of fat to the meal.

In one embodiment, dehydrated (e.g., spray dried) meat powder or concentrated meat broth may be used to prepare the improved compositions. In one aspect, such meat powder or meat broth are examples of “protein mix” in this disclosure.

In one embodiment, the protein mix of this disclosure may be derived from animals, plants or insects. In one aspect, the protein mix may be prepared from various species of poultry. Examples of poultry may include, for example, chicken, turkey, duck or other birds. In another embodiment, the protein mix may be derived from beef, pork, lamb and other domestic animals grown for food as well as from wild game. In another embodiment, the protein mix may be derived from insects.

In one embodiment, the protein mix may contain from 1% to 99% (w/w) protein. In another embodiment, the protein concentration of the meat powder and broth compositions may be from 20% to 99% (w/w), 40% to 99% (w/w) 60% to 99% (w/w), or as high as 80%, 90%, or 99% (w/w). In another embodiment, the protein mix may contain at least 90% (w/w) animal protein. The high protein powder or broth may help boost the total protein content of the composition. In one aspect, the total protein content of the composition is from about 20% to about 80%. In another aspect, the total protein content of the composition is from about 40% to about 60%.

In one embodiment, the protein mix may contain one or more peptides having 10 or fewer amino acids. In another embodiment, the protein mix may contain one or more amino acids selected from the group consisting of arginine, lysine, methionine, leucine, isoleucine, valine and combination thereof. In another embodiment, the protein mix may contain one or more branched chain amino acids, and the content of these branched chain amino acids in the protein mix is higher than content of branched chain amino acids in the comfort food before the protein mix is added.

In certain embodiments, the protein mix, such as poultry powder and broth may be prepared according to methods described in U.S. patent application Nos. 14/325,694; 14/698,150; 14/698,274 and 14/698,332, which are hereby incorporated into this application by reference.

### DETAILED DESCRIPTION

The term “comfort food” is used to generally describe a number of traditional food items that typically have high levels of carbohydrate and calorie but relatively lower protein content. Examples of comfort foods may include but are not limited to macaroni & cheese, casserole, mashed potato, pot pie, spaghetti sauce, grilled cheese, pasta, noodle, snack crisps, chips, soup, chowder, sauce, grits, breakfast cereals, grain-creamed cereals, bread, battered dough, snack mix and gravy, among others.

The present disclosure provides compositions that have enhanced protein content. In one embodiment, a protein mix may be added to a traditional comfort food to obtain an improved composition having higher protein content. In one embodiment, the protein mix is enriched in animal, plant or insect proteins. In another embodiment, the protein mix is a dehydrated high protein powder or broth prepared from natural meat, such as poultry.

In one embodiment, the dehydrated meat powder may be extracted from animal meat, meat on bones, or bones in a mechanical meat separation process. The meat and/or bone may be cooked in slurry and the fraction of fat is removed and the solid protein is collected as well as the water or broth fraction. The protein and broth fractions may be collected and dried by different process methods. Examples of drying process methods may include but are not limited to air drying, spray drying or other methods known in the art.

In another embodiment, the meat powder may be derived from a rendering process.

In one aspect, the protein mix may contain hydrolyzed protein. In another aspect, the protein mix may be prepared from acidic or enzymatic treatment. This protein mix may have an enhanced functionality, which may include, for example, particle size, texture, solubility, ingredient bind, water holding, flavor or other chemical and physical properties. In another aspect, the protein mix may contain higher content of branched chain amino acids.

In another embodiment, peptides, derivative amino acids and metabolite constituents or compounds may be added to the protein mix. Examples of such peptides, derivative amino acids and metabolite constituents or compounds may include but are not limited to creatine, creatinine, carnosine, taurine, L-carnitine and anserine.

The terms “poultry part” and “animal part” refer to parts of a bird or an animal, as well as whole bird or whole animal. For purpose of this disclosure, the term “animal” includes but not limited to cattle, poultry, pigs, domestic animals, wild animals, among others. The term “organism” refers to any living species, such as animals, plants, insect, among others.

The term “broth” refers to an aqueous composition containing at least one solute. A broth may be a liquid, a solution, or a suspension. For purpose of this disclosure, the term “broth” may be used interchangeably with the terms “stock,” “extract,” “fond,” or “demi-glace.” It is to be recognized that as a broth becomes more and more concentrated, it may become highly viscous and may have much lower liquidity as compared to a dilute broth. The concentrated broth composition of the present disclosure may be a highly concentrated broth in a liquid form. Alternatively, a concentrated broth composition may be a dried or semi-dried broth product in the form of powder or paste.

The term “elevated protein content” means the portion of the protein content that is increased over the protein content before the increase.

It is to be noted that, as used in this disclosure, the singular forms “a,” “an,” and “the” include plural referents unless the context clearly dictates otherwise. Thus, for example, reference to “a composition” includes reference to two or more of such compositions.

In another embodiment, the disclosed compositions may be prepared and/or distributed in a concentrated form.

### EXAMPLES

The following examples are provided to illustrate the present invention, but are not intended to be limiting. The reagents, materials and instruments are presented as typical components, and various substitutions or modifications may be made in view of the foregoing disclosure by one of skills in the art without departing from the principle and spirit of the present invention.

### Example 1 Preparation of a Protein Smoothie Having Added Dehydrated Poultry Protein Mix Added to the Fruit and Other Aqueous Ingredients

A protein smoothie was prepared containing a dry mix of fruit or fruit flavorings having added dehydrated poultry protein or protein from poultry broth mixed with other dry ingredients as listed below. The mix was added to other wet ingredients, such as water, ice, ice cream, fresh or frozen fruit, sugar or sugar syrups, and emulsifiers such as lecithin. Products prepared using this formula can be immediately consumed or they may be pasteurized in an HTST or UHT process. The pasteurized product may be packaged in cans, bottles or pouches or high pressure pasteurized (HPP) in a pouch and refrigerated. A dry mix may have the following ingredients, but other ingredients may be added as well.

Dry Smoothie Mix - Raspberry Peach

| | |
|---|---|
| Oat Bran | 30.6% |
| Dehydrated Chicken Powder (>67% protein) | 13.5% |
| Chicken Broth Powder (>90% Solids) | 11.4% |
| Raspberry Powder | 12.5% |
| Banana Powder | 10.4% |
| Dextrose | 8.3% |
| Orange Powder | 4.2% |
| Raspberry Extract | 3.5% |
| Cellulose Gum (CMC) | 2.1% |
| Citric Acid | 1.5% |
| Xanthan Gum | 1.1% |
| Peach Extract | 0.5% |
| Powdered Vanilla Extract | 0.4% |
| Total | 100% |

In a high speed mixer, 47 Kg of the Dry Smoothie Mix (from above) was added and blended with 467 Kg of water, 233 Kg of ice, 73 Kg of frozen raspberries, 73 Kg of frozen peaches and 107 Kg of Corn Syrup until mixed. The mixture was chilled immediately to less than 5° C. and ready to be consumed or pasteurized for shelf stable or refrigerated product. The amounts of all ingredients may be scaled up or down for smaller or larger scale manufacturing or for commercial production.

### Example 2 Preparation of a Macaroni & Cheese Sauce with Added Poultry Protein

A cheese sauce that contains dehydrated poultry protein or a broth with a high solids content that contains poultry protein can be formulated and mixed with macaroni noodles to make a typical comfort food with added protein.

Cheese Sauce Formula:

| | |
|---|---|
| Cheddar Cheese | 88.8% |
| Margarine/Shortening or Butter | 3.7% |
| Dehydrated Chicken Powder (>67% protein) | 3.7% |
| Chicken Broth Powder (>90% Solids) | 3.7% |
| Salt | 0.2% |
| Pepper | 0.1% |
| Total | 100% |

In a heated kettle, cheese sauce formula ingredients were combined and heated to temperature of 75° C. and mixed until a flowing sauce was achieved. Add equal portions (1:1) of cheese sauce to cooked pasta. For example, 280 grams of macaroni noodles with 280 grams of cheese sauce formula (from above). The macaroni and cheese preparation could be eaten as is or baked for 20 minutes at 350° F. The macaroni preparation could be filled in trays and frozen for use later. An 8 ounce serving of this macaroni preparation yields 28 g of protein. The amounts of all ingredients may be scaled up or down for smaller or larger scale manufacturing or for commercial production.

### Example 3 Pizza Sauce with Added Dehydrated Poultry Protein Added to a Pizza Crust and Pizza Ingredients

A tomato based pizza sauce with dehydrated poultry protein as a key ingredient to make a pizza with protein content.

Pizza Sauce Formula:

| | |
|---|---|
| Tomato Sauce | 52.7% |
| High Protein Dehydrated Chicken (85% Protein) | 39.6% |
| Salt | 1.9% |
| Brown Sugar | 1.9% |
| Oregano | 1.6% |
| Basil | 1.6% |
| Garlic | 0.5% |
| Pepper | 0.2% |

All pizza sauce ingredients were combined into a kettle and mix. When mixed, spread 8 ounces of pizza sauce on a 12 inch pizza crust. Add sliced mozzarella and basil leave to cover the pizza. One slice of pizza (8 slices per pizza) contains 21 grams of chicken protein. For long term storage, pizza sauce could be heated to 85° C. and filled in to cans or bottles and retorted to be shelf stable or into pouches and high pressure processed and stored refrigerated. The amounts of all ingredients may be scaled up or down for smaller or larger scale manufacturing or for commercial production.

### Example 4 High Protein Waffles

A traditional waffle recipe can have high protein dehydrated chicken added to increase the available protein to at least 56 grams of protein from chicken when added at 22.3% in the formula. Dehydrated chicken protein or other dehydrated proteins can be added at 1-23% to deliver desired protein content. Waffle Recipe (6 waffles/Servings) and the percent in the recipe

| | |
|---|---|
| 2 eggs | 3.0% |
| 1 cup of all-purpose flour | 22.3% |
| 1 cup of high protein dehydrated chicken powder (85% protein) | 22.3% |
| 1¾ cups of milk | 39.0% |
| ½ cup vegetable oil | 11.1% |
| 1 tablespoon sugar | 0.9% |
| 4 teaspoons baking powder | 1.2% |
| ¼ teaspoon salt | 0.1% |
| ½ teaspoon vanillas extract | 0.1% |

All dry ingredients (flour, chicken protein, baking powder and salt) were combined in a separate kettle and mix. In another kettle, eggs, milk, oil, sugar and vanilla were combined and mixed. Add dry ingredients to the egg, milk, oil, sugar and vanilla and mix until a batter is formed, Six Belgian styled waffles could be made from this recipe. Waffles can be consumed immediately upon cooking or frozen and packaged or vacuum packaged. The amounts of all ingredients may be scaled up or down for smaller or larger scale manufacturing or for commercial production.

### Example 5 Chicken Gravy with High Protein Chicken Powder

A high protein gravy that contain dehydrated chicken protein that can be used as a dressing for other foods such as meat, potatoes, and vegetables.

| | |
|---|---|
| 7.55 Kg Chicken Powder | 22.79% |
| 7.46 Kg Whey Protein Isolate 90% | 22.52% |
| 7.46 Kg Milk Protein Concentrate | 22.52% |
| 6.60 Kg Fiber DX100 | 19.92% |
| 0.80 Kg Chicken Flavor Extract | 2.41% |
| 0.25 Kg Flour salt | 0.75% |
| 0.50 Kg Natural Chicken Broth Flavor | 1.51% |
| 0.30 Kg Garlic powder | 0.91% |
| 0.10 Kg Onion powder | 0.30% |
| 0.38 Kg Turmeric Powder | 1.15% |
| 0.10 Kg White Pepper | 0.30% |
| 0.13 Kg Parsley | 0.39% |
| 0.50 Kg Butter flavor | 1.51% |
| 0.20 Kg Balsamic vinegar flavor | 0.60% |
| 0.80 Kg Freeze Dried Shallot | 2.41% |

All dry ingredients listed above were combined into a kettle and mixed. Combine 1 part of the dry mix with 4 parts of water and heat to 80° C. and hold for 15 minutes. The gravy may be consumed immediately or stored in pouches and bags and held refrigerated temperatures. The finished gravy could also be retorted in cans or bottles for shelf stable gravy. The amounts of all ingredients may be scaled up or down for smaller or larger scale manufacturing or for commercial production.

### Example 6 Pasta or Noodle with High Protein Chicken Powder

Protein mix containing chicken protein is added to pasta or noodle food to achieve 10% or higher protein content in the final pasta or noodle product.

### Example 7 Green Bean Casseroles with High Protein Chicken Powder

Protein mix containing chicken protein is added to Green Bean casseroles and similar casseroles to achieve 10% or higher protein content in the final product.

### Example 8 Tomato Soup with High Protein Chicken Powder

Protein mix containing chicken protein is added to tomato soup to achieve 10% or higher protein content in the final product.

### Example 9 Clam Chowder with High Protein Chicken Powder

Protein mix containing chicken protein is added to clam chowder to achieve 10% or higher protein content in the final product.

### Example 10 Grits or Other Grain-Creamed Cereals with High Protein Chicken Powder

Protein mix containing chicken protein is added to grits and other grain-creamed cereals to achieve 10% or higher protein content in the final product.

### Example 11 Bread or Battered Dough with High Protein Chicken Powder

Protein mix containing chicken protein is added to bread or battered dough to achieve 5% or higher protein content in the final product. Bread would include all wheat and grain based breads, rolls, cakes, cookies and muffins and such and battered dough could include pancake, waffle crepe and similar items.

### Example 12 Snack Mix with High Protein Chicken Powder

Protein mix containing chicken protein is added to snack mix that contains crunchy extruded protein chip, or cracker or cereal piece to achieve 1% or higher protein content in the final product. The snack mix may contain nuts, dehydrated fruit or vegetable pieces, popcorn, and other extruded chips, cereals, or grain pieces and can have an added flavor mix, such as barbeque or cinnamon.

Changes may be made in the disclosed compositions and methods without departing from the scope hereof. It should thus be noted that the matter contained in the above description should be interpreted as illustrative and not in a limiting sense. The following claims are intended to cover all generic and specific features described herein, as well as all statements of the scope of the present methods and compositions, which, as a matter of language, might be said to fall therebetween.

The contents of all cited references including literature references, patents, patent applications, and websites that maybe cited throughout this application are hereby expressly incorporated by reference in their entirety for any purpose, as are the references cited therein.

We claim:

1. A composition comprising a comfort food and a protein mix, wherein the composition has higher protein content than protein content of said comfort food, said protein mix contributing to said higher protein content of the composition.

2. The composition of claim 1, wherein proteins from the protein mix contribute to more than 50% of total protein content in said composition.

3. The composition of claim 1, wherein proteins from the protein mix contribute to more than 90% of total protein content in said composition.

4. The composition of claim 1, wherein the protein mix is prepared from a source selected from the group consisting of animal, plant and insect.

5. The composition of claim 1, wherein the comfort food is selected from the group consisting of macaroni & cheese, casserole, mashed potato, pot pie, spaghetti sauce, grilled cheese, pasta, noodle, snack crisps, chips, soup, chowder, sauce, grits, cereals, grain-creamed cereals, bread, battered dough, snack mix, gravy and combination thereof.

6. The composition of claim 1, wherein the composition is manufactured for commercial sale or commercial use.

7. The composition of claim 1, wherein the protein mix is prepared from poultry.

8. The composition of claim 1, wherein the protein mix is prepared from an organism selected from the group consisting of chicken, turkey, duck, ostrich, quail, goose, and combination thereof.

9. The composition of claim 1, wherein the composition comprises at least 5% (w/w) protein.

10. The composition of claim 1, wherein the composition comprises at least 20% (w w) protein.

11. The composition of claim 1, wherein the protein mix comprises one or more peptides having 10 or fewer amino acids.

12. The composition of claim 1, wherein the protein mix comprises one or more amino acids selected from the group consisting of arginine, lysine, methionine, leucine, isoleucine, valine and combination thereof.

13. The composition of claim 1, wherein the protein mix further comprises one or more branched chain amino acids.

14. The composition of claim 1, wherein the protein mix is a dehydrated protein powder.

15. The composition of claim 1, wherein the protein mix is a concentrated broth.

16. A method of making a composition, comprising adding to a comfort food a protein mix, wherein the composition has higher protein content than protein content of said comfort food, said protein mix contributing to said higher protein content of the composition.

17. The method of claim 16, wherein proteins from the protein mix contribute to more than 50% of total protein content in said composition.

18. The method of claim 16, wherein proteins from the protein mix contribute to more than 90% of total protein content in said composition.

19. The method of claim 16, wherein the composition is manufactured for commercial sale or commercial use.

20. The method of claim 16, wherein the comfort food is selected from the group consisting of macaroni & cheese, casserole, mashed potato, pot pie, spaghetti sauce, grilled cheese, pasta, noodle, snack crisps, chips, soup, chowder, sauce, grits, cereals, grain-creamed cereals, bread, battered dough, snack mix, gravy and combination thereof.

21. The method of claim 16, wherein the protein mix is prepared from a source selected from the group consisting of animal, plant and insect.

22. The method of claim 16, wherein the protein mix is prepared from poultry.
